(19) United States
(12) Patent Application Publication
(10) Pub. No.: US 2007/0209227 A1
(43) Pub. Date: Sep. 13, 2007

(54) Control Panel Assembly In Dryer

(75) Inventor: Soowon Park, Gyeongsangnam-do (KR)

Correspondence Address: MCKENNA LONG & ALDRIDGE LLP, 1900 K STREET, NW, WASHINGTON, DC, 20006, US

(73) Assignee: LG ELECTRONIC, INC.

(21) Appl. No.: 10/555,597

(22) PCT Filed: Jun. 17, 2005
(86) PCT No.: PCT/KR05/01887

§ 371 Date: Feb. 16, 2007

(30) Foreign Application Priority Data
Jun. 24, 2004 (KR) P 2004-47632

(51) Int. Cl. F26B 13/10

(52) U.S. Cl. 34/523

(57) ABSTRACT

A control panel assembly in a dryer is disclosed. The present invention includes a control panel selecting to control an operation of the dryer, a printed circuit board provided within the control panel wherein various circuits and devices to operate and control of the dryer are mounted on the printed circuit board, lead wires drawn from the various devices mounted on the printed circuit board, an insulator provided to the control panel, and at least one wire fixing member fixing the lead wires to one side of a lower end of the insulator. Therefore, the lead wires drawn from a PCB are hidden within a space between the insulator and the control panel to be fixed thereto. Accordingly, the present invention enhances assembly efficiency and protects the PCB wires.

### TECHNICAL FIELD

The present invention relates to a dryer, and more particularly, to a control panel assembly in a dryer, in which an insulator fixing to support a printed circuit board.

### BACKGROUND ART

Generally, a laundry dryer (hereinafter called a dryer) is a machine that dries an object to be dried in manner of absorbing moisture from the object by blowing hot air generated from a heater into a drum. And, the demand for the dryer is rising. Dryers can be divided into an exhaust type laundry dryer and a condensing type laundry dryer according to a handling method of humid air generated from drying an object to be dried by absorbing moisture. In the exhaust type laundry dryer, humid air generated from a drum is discharged outside the dryer. In the condensing type laundry dryer, humid air discharged from a drum is condensed by a condenser to remove moisture and the corresponding dry air is sent to the drum for re-circulation.

A control unit of a dryer according to a related art is explained in detail with reference to FIGS. 1 to 3 as follows.

Referring to FIGS. 1 to 3, a dryer is provided with a control panel 10 provided to an upper part of a front side of a body 1 to enable a user to selection and operate various functions of the dryer. And, printed circuit boards (hereinafter called PCB panels) 21 and 22, which are attached to insulators 31 and 32, respectively are fixed to a backside of the control panel 10. In this case, various circuits and electric devices are mounted on the PCB panels to operate the dryer.

The PCB panels 21 and 22 can be divided into a display PCB 21 performing functions associated with input/output via the control panel and a control PCB 22 performing functions associated with operation/control of dryer functions.

The insulators 31 and 32 are provided to rear sides (i.e., backsides of the surfaces on which the devices are mounted) of the display and control PCBs 21 and 22 to protect the PCB panels 21 and 22 and fixing to support the various devices mounted on the PCB panels 21 and 22 to determined positions on the control panel, respectively.

And, the display PCB 21 and the control PC 22 are electrically connected to each other via lead wires 23 drawn from the various devices mounted on the display PCB 21. However, a means for fixing the lead wires 23 within the control panel is not provided to the related art dryer.

Hence, in case of attempting to assemble the control panel 10 to the dryer body 1, the lead wires 23 may be stuck between the control panel 10 and the body 1. In this case, a coupling portion between the control panel 10 and the body 1 can be damaged. Moreover, since the coupling portion between the control panel 10 and the body 1 is relatively sharp, a portion of the corresponding lead wire 23 stuck in the coupling portion can be damaged as well.

For these reasons, in working, a worker needs to consider whether the interference takes place between the structures including the lead wires 23, the control panel 10 and the like. Hence, the assembly becomes complicated, assembly efficiency is lowered, and a working time is extended.

### TECHNICAL PROBLEM

Accordingly, the present invention is directed to a control panel assembly in a dryer that substantially obviates one or more of the problems due to limitations and disadvantages of the related art.

### TECHNICAL SOLUTION

An object of the present invention is to provide a control panel assembly in a dryer, in which lead wires drawn from a PCB is hidden within a space between an insulator and a control panel to be fixed thereto, by which assembly efficiency is enhanced, and by which the PCB wires can be protected.

Additional features and advantages of the invention will be set forth in the description which follows, and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, a control panel assembly in a dryer according to the present invention includes a control panel selecting to control an operation of the dryer, a printed circuit board provided within the control panel wherein various circuits and devices to operate and control of the dryer are mounted on the printed circuit board, lead wires drawn from the various devices mounted on the printed circuit board, an insulator provided to the control panel, and at least one wire fixing member fixing the lead wires to one side of a lower end of the insulator.

Preferably, the at least one wire fixing member extends from the lower end of the insulator to have an ‘L’ shape.

Preferably, the wire fixing members are configured to oppose each other in a thickness direction of the insulator.

Preferably, a pair of the wire fixing members are configured to oppose each other to leave a predetermined distance from each other. More preferably, openings of the wire fixing members are configured to oppose each other.

Preferably, a locking portion is provided along an outer circumference of a lower part of the insulator to be locked in the control panel and the at least one wire fixing member has a height equal to or smaller than that of the locking portion. The at least one fixing member is configured to receive the lead wires in a space between the lower end of the insulator and the control panel.

Preferably, the at least one fixing member is configured separate from the insulator. More preferably, a ‘L’ shaped fixing portion is provided to one side of the at least one wire fixing member to be fixed to the insulator. More preferably, openings of the wire fixing members are provided to oppose each other.

To further achieve these and other advantages and in accordance with the purpose of the present invention, a dryer includes a control panel selecting to control an operation of the dryer, a printed circuit board provided within the control panel wherein various circuits and devices to operate and control of the dryer are mounted on the printed circuit board, lead wires drawn from the various devices mounted on the printed circuit board, an insulator provided to the control panel, and a pair of wire fixing members fixing the lead wires between the control panel and a lower end of the insulator. Preferably, a pair of the wire fixing members are provided to guide the lead wires to converge in a lateral side of the insulator.

Preferably, each of a pair of the wire fixing members extends from the lower end of the insulator to have an ‘L’ shape in one body.

### ADVANTAGEOUS EFFECTS

Therefore, by fixing the lead wires drawn from the PCB are fixed to the wire fixing member provided between the control panel and the lower end of the insulator fixing the PCB thereto, the present invention prevents the lead wires from being stuck between the control panel and the body cabinet and the like in assembling the control panel.

In particular, since the lead wires are hidden within the space between the control panel and the lower end of the insulator, it is able to prevent the lead wires from being damaged in assembling the control panel to the body cabinet.

And, the present invention prevents the control panel and/or the body and the like from being damaged. Specifically, by protecting the lead wires, the present invention prevents the product robustness from being lowered.

It is to be understood that both the foregoing general description and the following detailed description are exemplary and explanatory and are intended to provide further explanation of the invention as claimed.

### DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a front diagram of a dryer according to a related art;

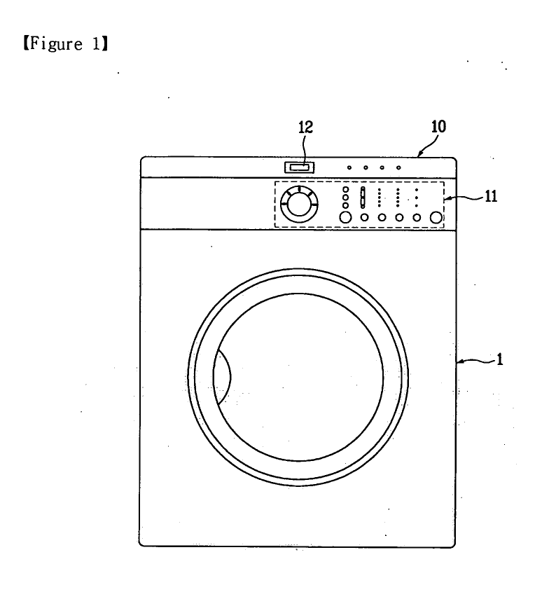

FIG. 2 is a perspective diagram of an insulator and a display PCB in a dryer according to a related art;

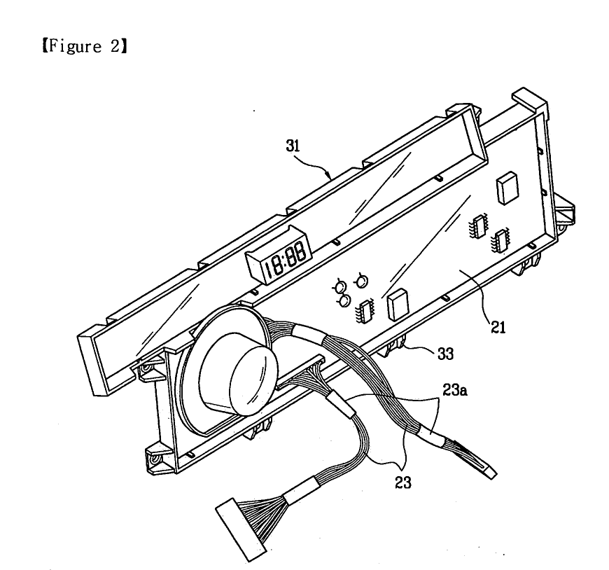

FIG. 3 is a perspective diagram of an assembly of an insulator and a control panel in FIG. 2;

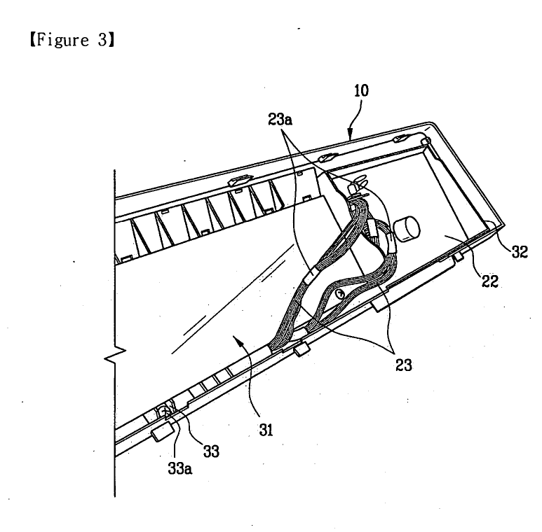

FIG. 4 is a perspective diagram of an assembly of an insulator and a PCB panel according to the present invention; and

FIG. 5 is a perspective diagram of an assembly of an insulator and a control panel in FIG. 4.

### BEST MODE

Reference will now be made in detail to the preferred embodiments of the present invention, examples of which are illustrated in the accompanying drawings.

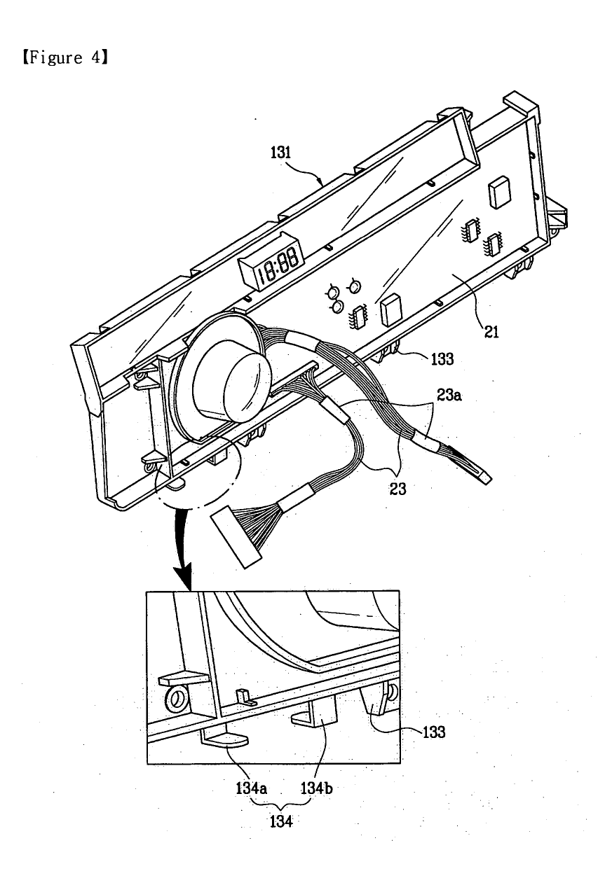

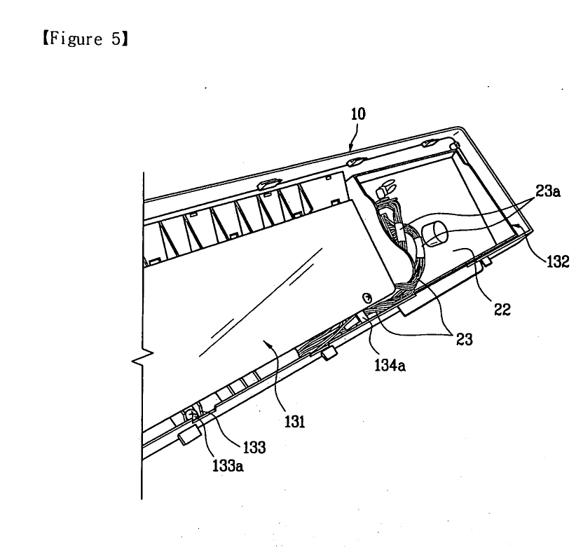

FIG. 4 is a perspective diagram of an assembly of an insulator and a PCB panel according to the present invention and FIG. 5 is a perspective diagram of an assembly of an insulator and a control panel in FIG. 4.

Referring to FIG. 4 and FIG. 5, a plurality of operational buttons 11 and a control panel 10 having a display window 12 and the like are provided to an upper end of a front side of a body 1 of a dryer.

Each of the operational buttons 11 enables a user, who pushes a corresponding button, to operate one of various functions such as a power-on of the dryer and the like. And, the display window 12 is operative in displaying a user-selecting function, an operational state, a progress state, and a malfunction of the dryer.

PCBs 21 and 22, on which various circuits and electric devices for operations of the dryer are mounted, are provided within the control panel 10. The various electric devices including switches, LEDs (light-emitting diodes), segments and the like are mounted on each of the PCBs 21 and 22. And, the PCBs 21 and 22 can be divided into a display PCB 21 performing functions associated with input/output via the control panel and a control PCB 22 performing functions associated with operation/control of dryer functions.

The display PCB 21 is installed in a manner that a front side having the devices mounted thereon opposes a backside of the control panel 10 to allow the devices to confront the operational buttons 10 and the display window 12 of the control panel 10, respectively. And, a rear side of the control PCB 22 is attached to a control insulator 132 so that a front side of the control PCB 22 can face an inside of the dryer.

And, the display PCB 21 and the control PCB 22 are electrically connected to each other via lead wires 23 drawn from the various devices mounted on the display PCB 21.

The lead wires 23 are drawn from the display PCB 21 to converge on one side (right side in the drawing). The converging lead wires 23 are tied together by a separate tie means (wire tie, insulator tape or the like) 23a and are then connected to a connecting terminal of the control PCB 22.

A plurality of locking portions 133 are outwardly projected from prescribed locations of an outer circumference of each of the insulators 131 and 132. The insulators 131 and 132 are fixed to the control panel 10 by locking screws in locking holes provided to the locking portions 133, respectively.

In this case, a reserved space is provided between a lower end of the insulator 131 and an inner lower end of the control panel 10 to have the same height of the locking portion 133 of the display insulator 131.

A wire fixing means 134 includes a pair of ‘L’ type ribs projected from a lower end of the display insulator 131 to oppose each other in a width direction of a surface forming a lower side of the display insulator 131 and to be spaced apart from each other.

In particular, the wire fixing member 134a or 134b extends downwardly to have the same length of the locking portion 133 provided to the lower end of the display insulator 131 and is then bent in the width direction to have the same width of the lower side of the display insulator 131. Hence, the wire fixing member 134a or 134b configures the ‘L’ shape.

Meanwhile, as mentioned in the above description in detail, it is apparent to those skilled in the art that the wire fixing member 134a or 134b can have any configurations that can fix the lead wires 23 to an area in the vicinity of the lower side of the display insulator 131.

For instance, a semi-circular ring or hook shape leaving a predetermined gap from an outer circumference of the insulator is applicable to the wire fixing member 134a or 134b. Yet, even if the various shapes are applicable to the wire fixing member 134a or 134b, it is preferable that openings of the wire fixing members 134a and 134b are installed to confront each other to stably fix the lead wires 23 thereto and to facilitate in attaching/detaching the lead wires 23 from the wire fixing member 134a or 134b. Alternatively, the wire fixing member 134 is formed separate from the insulator and is then installed at the insulator. For instance, the wire fixing member can be configured to have a ‘L’ shape having a hole at its one side to enable a screw locking. In this case, the wire fixing members can be screwed to the lower side of the insulator so that their openings oppose each other to leave a prescribed distance in-between.

Hence, as the lead wires 23 are hung in the openings of the wire fixing members 134a and 134b to be fixed thereto, the fixation of the lead wires 23 is facilitated. Besides, as the openings of a pair of the wire fixing member 134a and 134b are provided to oppose and support both sides of the lead wires 23, it is able to stably fix the lead wires 23 thereto.

The lead wires 23 are drawn from a front side of the display PCB 21, is tied at one side of the display insulator 131 and are then drawn to a rear side via a lower end of the display insulator 131.

The lead wires 23 are guided to the lower end of the display insulator 131, are then received between the two wire fixing members 134a and 134b in the right side of the display insulator 131, and one ends of the lead wires 23 are guided to the control PCB 22 provided right to the display PCB 21.

Therefore, since the lead wires 23 are hidden in the space between the display insulator 131 and the lower end of the control panel 10 by the fixing member 134 to be fixed thereto, it is able to prevent the lead wires from being stuck between the control panel 10 and the internal structure in assembling the control panel 10.

Moreover, the PCB fixing insulator is applicable to various electrical home appliances such as a washer needing a means for fixing a PCB panel and wires of the PCB panel and the like.

### INDUSTRIAL APPLICABILITY

Accordingly, the present invention hides the lead wires drawn from the PCB in the space between the control panel and the insulator, thereby enhancing the efficiency in assembling the control panel and the PCB and simplifying the corresponding manufacturing process. And, since the wire fixing member has the simple ‘L’ shape, the lead wires cab be fixed thereto in a simple manner to reduce the corresponding assembling time.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

1. A control panel assembly in a dryer, comprising:
a control panel selecting to control an operation of the dryer;
a printed circuit board provided within the control panel wherein various circuits and devices to operate and control of the dryer are mounted on the printed circuit board;
lead wires drawn from the various devices mounted on the printed circuit board;
*63 an insulator provided to the control panel; and
at least one wire fixing member fixing the lead wires to one side of a lower end of the insulator.

2. The control panel assembly of claim 1, wherein the at least one wire fixing member extends from the lower end of the insulator to have an ‘L’ shape.

3. The control panel assembly of claim 1, wherein the wire fixing members are configured to oppose each other in a thickness direction of the insulator.

4. The control panel assembly of claim 1, wherein a pair of the wire fixing members are configured to oppose each other to leave a predetermined distance from each other.

5. The control panel assembly of claim 4, wherein openings of the wire fixing members are configured to oppose each other.

6. The control panel assembly of claim 1, wherein a locking portion is provided along an outer circumference of a lower part of the insulator to be locked in the control panel and wherein the at least one wire fixing member has a height equal to or smaller than that of the locking portion.

7. The control panel assembly of claim 6, wherein the at least one fixing member is configured to receive the lead wires in a space between the lower end of the insulator and the control panel.

8. The control panel assembly of claim 1, wherein the at least one fixing member is configured separate from the insulator.

9. The control panel assembly of claim 8, wherein a ‘L’ shaped fixing portion is provided to one side of the at least one wire fixing member to be fixed to the insulator.

10. The control panel assembly of claim 8, wherein openings of the wire fixing members are provided to oppose each other.

11. A dryer comprising:
a control panel selecting to control an operation of the dryer;
a printed circuit board provided within the control panel wherein various circuits and devices to operate and control of the dryer are mounted on the printed circuit board;
lead wires drawn from the various devices mounted on the printed circuit board;
an insulator provided to the control panel; and
a pair of wire fixing members fixing the lead wires between the control panel and a lower end of the insulator.

12. The control panel assembly of claim 11, wherein a pair of the wire fixing members are provided to guide the lead wires to converge in a lateral side of the insulator.

13. The control panel assembly of claim 11, wherein each of a pair of the wire fixing members extends from the lower end of the insulator to have an ‘L’ shape in one body.
